(19) United States
(12) Patent Application Publication
(10) Pub. No.: US 2026/0043537 A1
(43) Pub. Date: Feb. 12, 2026

(54) UTILITY LIGHT ASSEMBLY

(71) Applicant: MILWAUKEE ELECTRIC TOOL CORPORATION, Brookfield, WI (US)

(72) Inventors: Jeremy A. Schmittinger, Waukesha, WI (US); Jacob W. Knight, Oconomowoc, WI (US)

(21) Appl. No.: 19/297,540

(22) Filed: Aug. 12, 2025

Related U.S. Application Data
(60) Provisional application No. 63/681,920, filed on Aug. 12, 2024.

(51) Int. Cl. F21V 21/088; F21S 4/28; F21S 9/02; F21V 21/005; F21V 21/29; F21Y 103/10; F21Y 115/10

(52) U.S. Cl. CPC F21V 21/0885; F21S 4/28; F21S 9/02; F21V 21/005; F21V 21/29; F21Y 2103/10; F21Y 2115/10

(57) ABSTRACT

A light assembly includes a housing, a first hood mount and a second hood mount extending from a first end of the housing and a second end of the housing, respectively, the first hood mount and the second hood mount each including an arm, and a grip coupled to a distal end of the arm and configured to engage the vehicle hood, a battery pack receiver coupled to the housing and movable along the housing, the battery pack receiver configured to removably receive a rechargeable battery pack, and a light source coupled to the housing and configured to generate light.

### CROSS-REFERENCE TO RELATED APPLICATIONS

This application claims priority to co-pending U.S. Provisional Patent Application No. 63/681,920, filed on Aug. 12, 2024, the entire contents of which are incorporated herein by reference.

### FIELD

The present disclosure relates to a light assembly, and more particularly to a utility light assembly couplable to an automobile.

### BACKGROUND

When working on the underhood components of a vehicle (e.g., engine, transmission, cooling system, etc.), for instance, when the vehicle is parked in a garage, the components may be difficult to see due to dim lighting conditions. Some common light assemblies only illuminate small areas of the engine bay and may be difficult to direct to a specific area. Other common utility light assemblies span the width of the hood but are not collapsible for storage in a compact space. Other utility light assemblies extend or project away from the hood of the vehicle and the light assembly may contact the user's head when the user is trying to get in a position to access an underhood component.

### SUMMARY

The present disclosure provides, in one aspect, a light assembly configured to be coupled to a vehicle hood, the light assembly including: a housing; a first hood mount and a second hood mount extending from a first end of the housing and a second end of the housing, respectively, the first hood mount and the second hood mount each including an arm, and a grip coupled to a distal end of the arm and configured to engage the vehicle hood; a battery pack receiver coupled to the housing and movable along the housing, the battery pack receiver configured to removably receive a rechargeable battery pack; and a light source coupled to the housing and configured to generate light.

The present disclosure provides, in another aspect, a light assembly configured to be coupled to a vehicle hood, the light assembly including: a housing having a first housing portion and a second housing portion slidable relative to the first housing portion to change an overall length of the housing; a first hood mount extending from the first housing portion and a second hood mount extending from the second housing portion, the first hood mount and the second hood mount each including an arm, and a grip coupled to a distal end of the arm and configured to engage the vehicle hood; a battery pack receiver coupled to the housing, the battery pack receiver configured to removably receive a rechargeable battery pack; and a light source coupled to the housing and configured to generate light.

The present disclosure provides, in another aspect, a light assembly configured to be coupled to a vehicle hood, the light assembly including: a housing; a first hood mount and a second hood mount extending from a first end of the housing and a second end of the housing, respectively, the first hood mount and the second hood mount each including an arm, and a grip coupled to a distal end of the arm and configured to engage the vehicle hood; a battery pack receiver coupled to the housing, the battery pack receiver configured to removably receive a rechargeable battery pack, the battery pack receiver being removable from the housing; and a light housing coupled to the battery pack receiver such that the light housing is removable from the housing with battery pack receiver, the light housing supporting a light source.

Other features and aspects of the invention will become apparent by consideration of the following detailed description and accompanying drawings.

### BRIEF DESCRIPTION OF THE DRAWINGS

FIG. 1 is a perspective view of a light assembly according to the present disclosure coupled to a hood of a vehicle.

FIG. 2 is another perspective view of the light assembly of FIG. 1 coupled to the hood of the vehicle.

FIG. 3 is a perspective view of the light assembly of FIG. 1 in a retracted position.

FIG. 4 is a perspective view of the light assembly of FIG. 1 in an expanded position.

FIG. 4A is a section view of the light assembly of FIG. 1 along section line A-A.

FIG. 5 is a perspective view of another embodiment of a light assembly.

FIG. 5A is a section view of the light assembly of FIG. 5,

FIG. 6 is a perspective view of the light assembly of FIG. 5 coupled to a hood of a vehicle.

FIG. 7 is another perspective view of the light assembly of FIG. 5 coupled to the hood of the vehicle.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

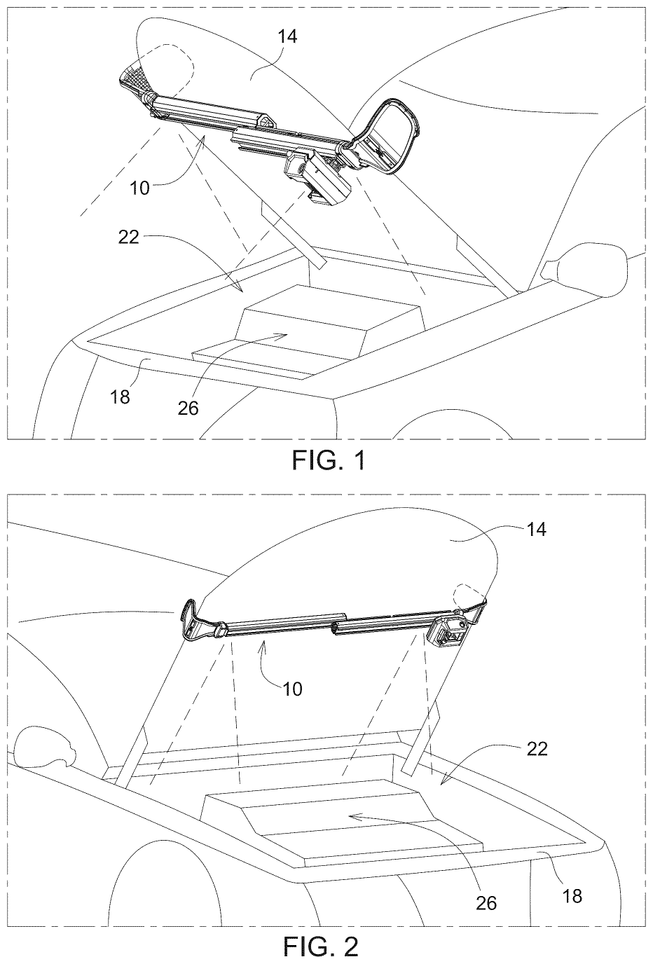

FIGS. 1 and 2 illustrate a first embodiment of a utility light assembly 10 (“light assembly”) removably coupled to a hood 14 of a vehicle 18 to illuminate an engine bay 22 and underhood components 26 (e.g., engine, transmission, cooling system, battery, etc.) situated within the engine bay 22. As shown in FIGS. 1 and 2, the light assembly 10 has a low profile and is positioned close to the hood 14. That is, the light assembly 10 does not project away from the hood 14 a substantial distance, thereby maximizing the amount of headroom available to the user working on the vehicle 18 and reducing the instances of the user's head contacting the light assembly 10.

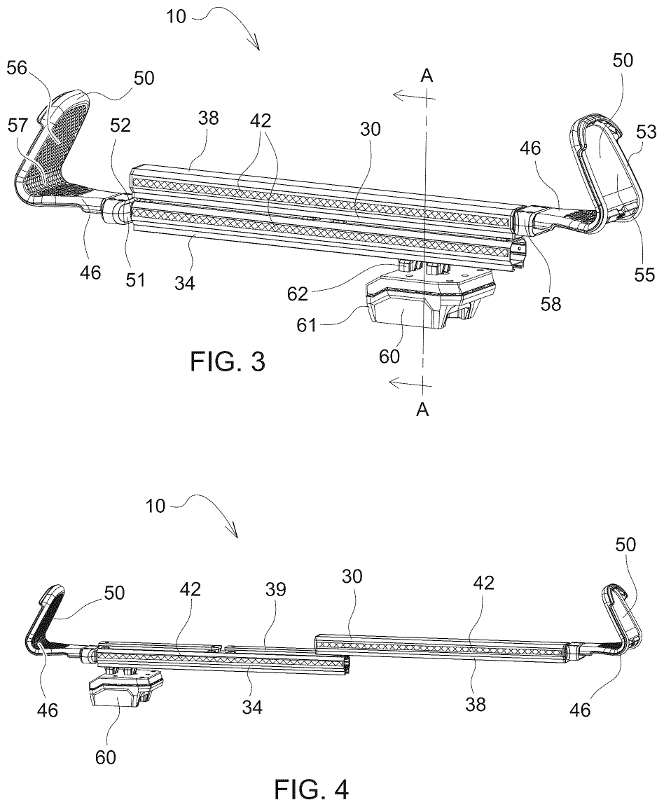

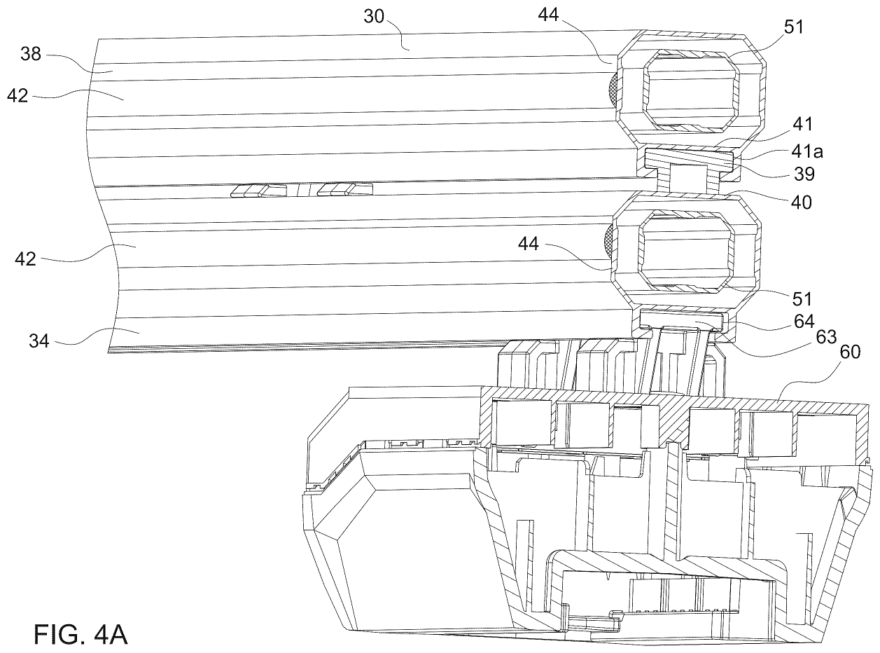

As shown in FIGS. 3, 4, and 4A, the light assembly 10 includes a housing 30 with first and second housing portions 34, 38 that are movably (e.g., slidably) coupled to one another so as to be movable between a retracted position (FIG. 3) for compact storage, and an extended, or deployed, position (FIG. 4) to be coupled to the hood 14 of the vehicle 18 (e.g., to the hood) and span the length of the engine bay 22. In other words, the first and second housing portions 34, 38 are movable relative to one another to adjust or change an overall length of the housing 30. In the retracted position, the first and second housing portions 34, 38 at least partially overlap. In the illustrated embodiment, the first and second housing portions 34, 38 overlap over approximately the entire length of the first and second housing portions 34, 38. The first and second housing portions 34, 38 are formed as hollow tubes. A rail portion 39 is coupled to the first housing portion 34 on an upper surface 40 of the first housing portion 34 and is received in a slot 41a defined in the lower wall 41 of the second housing portion 38. The rail portion 39 has a T-shape that is received in the slot 41a of the second housing portion 38 that has a corresponding T-shape. The second housing portion 38 is slidable along the rail portion 39. A stop (not shown) may be coupled to the second housing portion 38 to engage the first housing portion 34 (e.g., the rail portion 39) to limit the travel of the second housing portion 38 relative to the first housing portion, thereby defining the extended position.

In the extended position shown in FIG. 4, the light assembly 10 illuminates a majority of the length of the engine bay 22 and may illuminate the entire length of the engine bay 22, as shown in FIGS. 1 and 2. In some embodiments, the first and second housing portions 34, 38 may include a detent mechanism or other suitable latch mechanism to maintain the first and second housing portions 34, 38 in the extended position and/or in the retracted position.

The first and second housing portions 34, 38 each support a light source 42 that generates a light to illuminate underhood components. In the illustrated embodiment, the light source 42 is a plurality of light-emitting diodes, LEDs, arranged as an LED light strip. In other embodiments, the light source may be another type of light source (individual LEDs, bulbs, etc.). The light sources 42 are coupled to sides 44 or edges of the housing portions 34, 38. The light sources 42 may also or alternatively be coupled to bottom-facing surfaces of either or both of the housing portions 34, 38.

A hood mount 46 is at least partially slidably supported within each of the first and second housing portions 34, 38 such that each hood mount 46 is telescopically extendable from the respective first and second housing portions 34, 38 in opposite directions. Each hood mount 46 includes a grip 50 that is coupled to a distal end of an arm 51. The hood mount 46 is biased to a retracted position by a biasing member (not shown) to maintain a grip on the hood 14 when the light assembly 10 is coupled to the hood. The biasing member may be a tension spring, a roller spring, an elastic band, or other structure capable of applying a biasing force to the hood mount. In the retracted position, at least a majority of the arm 51 is sleeved within the respective first or second housing portion 34, 38 and the grip 50 is positioned adjacent the end 52 of the first housing portion 34 or the second housing portion 38.

Each grip 50 includes a grip wire 53 coupled to the arm 51 and a grip cover 55 coupled to the grip wire 53. The grip wire 53 is formed in a paddle shape to provide an extended surface area 56 (e.g., a longer and wider surface area) to increase the area in contact with the hood 14. In other embodiments, the grip wire 53 may be formed in another manner. For instance, in some embodiments, the grip 50 may include two separate grip wires formed in a hook shape, each grip wire at least partially, or entirely surrounded by a grip cover formed substantially in a cylinder. The grip wire 53 of the present embodiment is bendable to conform to different hood shapes. The grip cover 55 is formed of an elastomeric material. It will be appreciated that an elastomeric material provides a scratchless as well as higher-friction contact between the hood 14 and the light assembly 10. The surface area 56 of the grip cover is formed with a gripping pattern 57 that further increases the friction between the grip cover 55 and the hood 14. In the present embodiment, the gripping pattern is formed as a pattern of nested hexagons. In other embodiments, other patterns (e.g., triangular, quadrilateral, octagonal, etc.) may be used. The grip wire 53 is coupled to and clamped in a clamp 58 coupled to the end of the arm 51.

A battery pack receiver 60, or receptacle, is coupled to the first housing portion 34. The battery pack receiver 60 may be movable (e.g., slidable) relative to the first housing portion 34. That is, the battery pack receiver 60 may be movable along the first housing portion 34 to move out of the way of a user, as needed. The battery pack receiver 60 removably receives a battery pack (not shown) that provides power to the light sources 42. The battery pack may be any capacity rechargeable battery pack (e.g., 12 V, 18 V, etc.). The battery pack receiver 60 may include an actuator (not shown) to operate the light assembly 10 (i.e., turn the light assembly 10 on and off), or otherwise change the operation of the light assembly 10 (e.g., change the brightness, turn on one light source but not another, etc.). In some embodiments, the actuator may be located elsewhere on the light assembly 10. The battery pack receiver 60 includes a receiver portion 61 and a slide portion 62. The receiver portion 61 is configured to receive the battery pack in a sliding manner and may include one or more rails along which the battery pack is slidable, and one or more latches configured to engage the battery pack and retain the battery pack in a coupled manner with the battery pack receiver 60. The receiver portion 61 also includes terminals (not shown) that engage the battery pack and electrically couple the battery pack to the light source 42 to supply electricity from the battery pack to the light source 42. The slide portion 62 extends away from the receiver portion 61 and include a T-shaped flange 63. The T-shaped flange 63 is received in slot 64 defined in a lower surface of the first housing portion 34. The slot 64 has a cross-section corresponding to the T-shaped flange 63. In other embodiments, the T-shaped flange 63 and slot 64 may be formed in another shape allowing the battery pack receiver 60 to slide along the first housing portion 34. In other embodiments, the battery pack receiver may be coupled to the housing 30 in another manner. In some embodiments, the battery pack receiver 60 is removable from the housing.

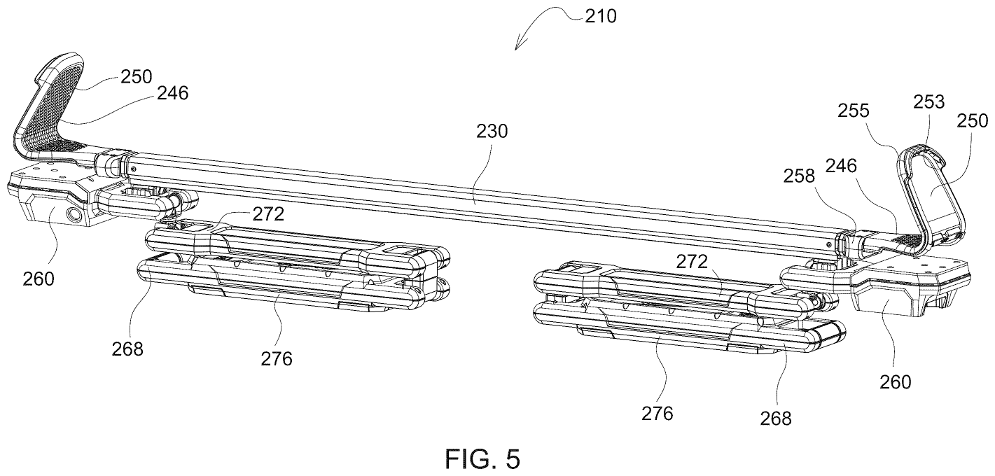

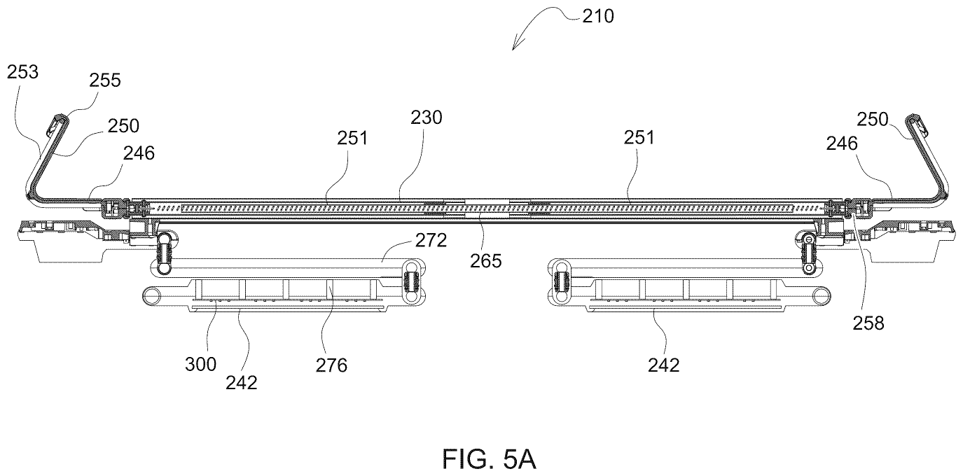

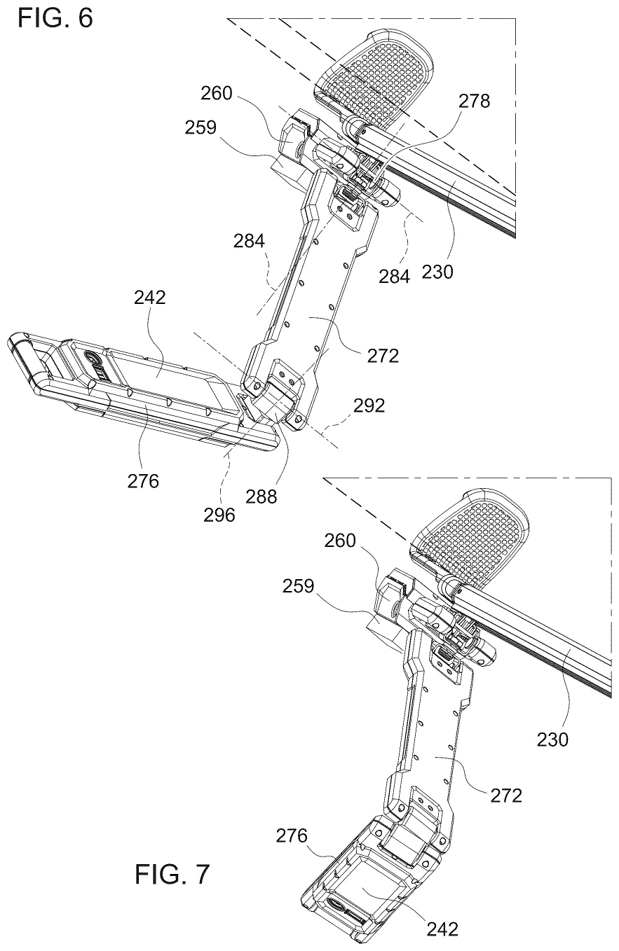

FIGS. 5-7 illustrate another embodiment of a light assembly 210, with like components and features as the embodiment of the light assembly 10 shown in FIGS. 1-4A being labeled with like references numerals plus “200.” Due to the similarities between the embodiments of the light assemblies 10, 210, only differences between the embodiments will be described.

The light assembly 210 includes a housing 230 to which one or more light sources 242 are coupled. The housing 230 is formed as a hollow tube that receives first and second hood mounts 246. The first and second hood mounts 246 are telescopically extendible from opposite ends of the housing 230. Each hood mount 246 includes a grip 250 including a grip cover 255 coupled to a grip wire 253 which is coupled to a clamp 258 at a distal end of an arm 251, with each arm 251 positioned substantially entirely within the housing 230 when the hood mount 246 is at a retracted position (shown in FIGS. 5-7). A biasing element 265 is coupled to the clamps 258 within the arms 251 and housing 230. The biasing element 265 is configured as a tension spring that applies a biasing force to each hood mount 246 in an equal and opposite direction to balance the force applied through the hood mounts 246 to the hood 14.

The light assembly 210 includes two battery pack receivers 260, or receptacles, that are each coupled to a light housing 268. Each battery pack receiver 260 receives a battery 259 that is substantially similar to the battery packs described above with regard to the first embodiment of the light assembly 10. The battery pack receivers 260 and light housing 268 are positionable along a length of the housing 230. For example, the battery pack receivers 260 may be movable (e.g., slidable) along the housing 230 using a track similar to the rail portion 39 and the slot 41a described above. In some embodiments, each battery pack receiver 260 may be decoupled from the housing 230 such that the battery pack receiver 260 and light housing 268 are usable remote from the housing 230 (e.g., one light housing 268 may be carried underneath a vehicle to illuminate the underbody of the vehicle, while the housing 230 and another battery pack receiver 260 and light housing 268 continue to directly light from the hood 14 above the vehicle 18).

Each light housing 268 includes a first light housing portion 272 coupled to the battery pack receiver 260 and a second light housing portion 276 pivotally coupled to the first light housing portion 272. The first light housing portion 272 is coupled at a pivotal coupling 278 that allows the first light housing portion 272 to pivot relative to the battery pack receiver 260 about a first rotation axis 280 and a second rotation axis 284. The first rotation axis 280 and second rotation axis 284 are oriented perpendicularly to one another. The second light housing portion 276 is coupled to the first light housing portion 272 at a pivotal coupling 288 that allows the second light housing portion 276 to pivot relative to the first light housing portion 272 about a third pivot axis 292 and a fourth pivot axis 296. The third pivot axis 292 and the fourth pivot axis 296 are arranged perpendicularly to one another.

The second housing portion 276 houses the light source 242 (e.g., a printed circuit board assembly 300 that supports one or more LEDs).

Although the invention has been described in detail with reference to certain preferred embodiments, variations and modifications exist within the scope and spirit of one or more independent aspects of the invention as described.

What is claimed is:

1. A light assembly configured to be coupled to a vehicle hood, the light assembly comprising:
a housing;
a first hood mount and a second hood mount extending from a first end of the housing and a second end of the housing, respectively, the first hood mount and the second hood mount each including
an arm, and
a grip coupled to a distal end of the arm and configured to engage the vehicle hood;
a battery pack receiver coupled to the housing and movable along the housing, the battery pack receiver configured to removably receive a rechargeable battery pack; and
a light source coupled to the housing and configured to generate light.

2. The light assembly of claim 1, wherein the housing includes a first housing portion and a second housing portion movable relative to the first housing portion to change an overall length of the housing.

3. The light assembly of claim 2, wherein the housing includes a rail coupled to the first housing portion and received by the second housing portion, and wherein the second housing portion is slidable along the rail.

4. The light assembly of claim 2, wherein the light source includes a first light strip coupled to the first housing portion and a second light strip coupled to the second housing portion.

5. The light assembly of claim 1, wherein the battery pack receiver is removable from the housing.

6. The light assembly of claim 5, wherein the light source is coupled to the battery pack receiver such that the light source is removable from the housing with the battery pack receiver.

7. The light assembly of claim 6, wherein the light source is a first light source and the battery pack receiver is a first battery pack receiver, the light assembly further comprising:
a second battery pack receiver coupled to the housing and movable along the housing, the second battery pack receiver configured to removably receive a rechargeable battery pack, the second battery pack receiver being removable from the housing; and
a second light source coupled to the second battery pack receiver such that the second light source is removable from the housing with the second battery pack receiver, the second light source configured to generate light.

8. The light assembly of claim 1, wherein the light source is supported in a light housing that is pivotally coupled to the battery pack receiver.

9. The light assembly of claim 8, wherein the light housing is pivotable relative to the battery pack receiver about a first axis and a second axis that is perpendicular to the first axis.

10. The light assembly of claim 9, wherein the light housing includes a first light housing portion coupled to the battery pack receiver and a second light housing portion pivotally coupled to the first light housing portion, wherein the light source is supported in the second light housing portion.

11. The light assembly of claim 10, wherein the second light housing portion is pivotable relative to the first light housing portion about a third pivot axis and a fourth pivot axis that is perpendicular to the third pivot axis.

12. The light assembly of claim 1, wherein the first hood mount and the second hood mount are telescopically extendible from the first and second ends of the housing are biased to a retracted position in which the grips are positioned adjacent the first and second ends of the housing.

13. The light assembly of claim 1, wherein the housing includes a rail portion along which the battery pack receiver is movable.

14. A light assembly configured to be coupled to a vehicle hood, the light assembly comprising:
a housing having a first housing portion and a second housing portion slidable relative to the first housing portion to change an overall length of the housing;
a first hood mount extending from the first housing portion and a second hood mount extending from the second housing portion, the first hood mount and the second hood mount each including
an arm, and
a grip coupled to a distal end of the arm and configured to engage the vehicle hood;
a battery pack receiver coupled to the housing, the battery pack receiver configured to removably receive a rechargeable battery pack; and
a light source coupled to the housing and configured to generate light.

15. The light assembly of claim 14, wherein the housing includes a rail coupled to the first housing portion and received by the second housing portion, and wherein the second housing portion is slidable along the rail.

16. The light assembly of claim 14, wherein the light source includes a first light strip coupled to the first housing portion and a second light strip coupled to the second housing portion.

17. A light assembly configured to be coupled to a vehicle hood, the light assembly comprising:
a housing;
a first hood mount and a second hood mount extending from a first end of the housing and a second end of the housing, respectively, the first hood mount and the second hood mount each including
an arm, and
a grip coupled to a distal end of the arm and configured to engage the vehicle hood;
a battery pack receiver coupled to the housing, the battery pack receiver configured to removably receive a rechargeable battery pack, the battery pack receiver being removable from the housing; and
a light housing coupled to the battery pack receiver such that the light housing is removable from the housing with battery pack receiver, the light housing supporting a light source.

18. The light assembly of claim 17, wherein the battery pack receiver is a first battery pack receiver and the light housing is a first light housing, the light assembly further comprising:
a second battery pack receiver coupled to the housing, the second battery pack receiver configured to removably receive a rechargeable battery pack, the second battery pack receiver being removable from the housing; and
a second light housing coupled to the second battery pack receiver such that the second light housing is removable from the housing with the second battery pack receiver, the second light housing supporting a light source.

19. The light assembly of claim 17, wherein the light housing is pivotable relative to the battery pack receiver about a first axis and a second axis that is perpendicular to the first axis.

20. The light assembly of claim 19, wherein the light housing includes a first light housing portion coupled to the battery pack receiver and a second light housing portion pivotally coupled to the first light housing portion, wherein the second light housing portion is pivotable relative the first light housing portion about a third axis and a fourth axis that is perpendicular to the third axis, and wherein the light source is supported in the second light housing portion.
